(19) United States
(12) Patent Application Publication
(10) Pub. No.: US 2004/0219813 A1
(43) Pub. Date: Nov. 4, 2004

(54) Memory card connector with switch terminals

(76) Inventor: Chia-Chen Chang, Hsin Chung City (TW)

Correspondence Address: MOLEX INCORPORATED, 2222 WELLINGTON COURT, LISLE, IL, 60532, US

(21) Appl. No.: 10/806,265

(22) Filed: Mar. 22, 2004

(30) Foreign Application Priority Data
Mar. 21, 2003 (TW) 92204479

(51) Int. Cl. H01R 29/00

(52) U.S. Cl. 439/188

(57) ABSTRACT

A memory card connector has a cavity for receiving a memory card. An insulative housing includes a rear terminal-mounting section at the rear of the cavity and which mounts a plurality of connector terminals. The terminals have forwardly extending contact portions for engaging appropriate contacts on the memory card. The housing has a base forwardly of the rear terminal-mounting section. The base has a baffle surface located between a pair of the forwardly extending contact portions. A first switch terminal is mounted on the housing and has a contact portion near the rear of the cavity. A second switch terminal is mounted on the housing and has a flexible contact arm engageable by the memory card and movable by the card into engagement with the contact portion of the first switch terminal. The flexible contact arm has a depending baffle projection engageable with the baffle surface on the base of the housing for locating the flexible contact arm.

### FIELD OF THE INVENTION

This invention generally relates to the art of electrical connectors and, particularly, to a memory card connector.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smartphones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card, itself, writes or reads via the connector and can transmit between electrical appliances, such as a word processor, personal computer, personal data assistant or the like. The card may be used in applications such as mobile or cellular telephones which are actuated and permit data access after identifying an identification code stored on a SIM (subscriber identification module) card. The SIM card has a conductive face with an array of contacts, and the mobile phone has a SIM card connector with terminals for electrical connection with the contacts of the SIM card to ensure the subscriber identification confirmation.

A typical memory card connector includes some form of dielectric housing which is covered by a metal shell. The metal shell may be stamped and formed of sheet metal material and formed substantially into a box-shape. The metal shell and the housing combine to define a card-receiving cavity. One end of the cavity is open to form a card-insertion opening. The dielectric housing may be generally L-shaped or U-shaped and includes a rear terminal-mounting section at the rear of the cavity, and at least one longitudinal side wall section extends forwardly from one or both ends of the rear section at one or both sides of the cavity. The metal shell has a top plate substantially covering the dielectric housing, with side plates extending downwardly over the side wall sections of the housing. The side plates of the metal shell and/or the side wall sections of the housing define the sides of the card-receiving cavity.

One or more of the above design features of a conventional memory card connector, generally designated 8, is shown in FIG. 1 wherein an insulative housing, generally designated 10, mounts a plurality of connector terminals, generally designated 12. The housing has a rear terminal-mounting section 14, along with a pair of side wall sections 16 to define a generally U-shaped configuration. A generally flat or planar base 18 spans side wall sections 16 at the bottoms thereof forwardly of the rear terminal-mounting section 14. Typically, a metal shell (not shown) is mounted on top of the housing and combines therewith to define an interior cavity 20 for receiving a memory card between side walls sections 16 of the housing above base 18. Appropriate contacts on the memory card engage cantilevered contact portions 12a of connector terminals 12. The contact portions extend forwardly into the cavity.

The prior art connector 8 of FIG. 1 includes a first switch terminal, generally designated 22, which includes a contact arm 22a projecting into cavity 20 immediately in front of the rear terminal-mounting section 14 of the housing. A second switch terminal 24 includes a resilient contact arm 24a which is angled forwardly into cavity 20 in front of the contact arm 22a of first switch terminal 22.

When a memory card is inserted into cavity 20 of memory card connector 8, a leading edge of the memory card engages contact arm 24a of switch terminal 24 and biases the contact arm into engagement with contact arm 22a of switch terminal 22. This automatically closes the “switch” defined by the two switch terminals.

A problem with the prior art connector 8 shown in FIG. 1 is that resilient contact arm 24a of second switch terminal 24 is exposed during handling and assembly and, thereby, can be bent into engagement with contact portions 12a of connector terminals 12. This not only could cause damage to the connector terminals, but the connector terminals could be shorted by switch terminal 12 and result in damage to the circuitry on a printed circuit board to which connector 8 is mounted.

FIG. 2 shows another prior art memory card connector, generally designated 8A, which includes an insulative housing, generally designated 10. Again, the housing has a rear terminal-mounting section 14, side wall sections 16 and a base 18 which define a cavity 20. Connector terminals 12 are mounted in rear terminal-mounting section 14. The connector terminals have forwardly extending contact portions 12a.

Like connector 8 of FIG. 1, connector 8A of FIG. 2 includes a first switch terminal 22 having a contact arm 22a projecting into cavity 20 immediately in front of the rear terminal-mounting section of the housing. A second switch terminal, generally designated 24, includes a resilient contact arm 24a which is angled forwardly into the cavity in front of contact arm 22a of switch terminal 22.

Base 18 of memory card connector 8A includes a pair of upstanding flanges 26 for each contact portion 12a of a respective connector terminal 12. Each pair of upstanding flanges 26 define a slot 28 therebetween and within which the respective contact portion 12a is disposed. In order to prevent resilient contact arm 24a of second switch terminal 24 from engaging contact portions 12a of connector terminals 12, a block 30 projects upwardly from base 18 of the housing to a height above the height of contact portions 12a. Therefore, during handling, moving or assembly, if resilient contact arm 24a is pushed downwardly, the arm will engage block 30 and not engage contact portions 12a of connector terminals 12. This will prevent damage to or shorting of contact portions 12a. Unfortunately, problems still are encountered because resilient contact arm 24a can be swung or pivoted outwardly and become damaged or bent because it is not fixed in any location.

The present invention is directed to solving these various problems.

### SUMMARY OF THE INVENTION

An object, therefore, of the invention is to provide a new and improved memory card connector of the character described.

In the exemplary embodiment of the invention, a memory card connector has a cavity for receiving a memory card. An insulative housing has a rear terminal-mounting section at the rear of the cavity and which mounts a plurality of connector terminals having forwardly extending contact portions for engaging appropriate contacts on the memory card. The housing has a base forwardly of the rear terminal-mounting section. The base has a baffle surface located between a pair of the forwardly extending contact portions. A first switch terminal is mounted on the housing and has a contact portion near the rear of the cavity. A second switch terminal is mounted on the housing and has a flexible contact arm engageable by the memory card and movable by the card into engagement with the contact portion of the first switch terminal. The flexible contact arm has a depending baffle projection engageable with the baffle surface on the base of the housing for locating the flexible contact arm.

According to an aspect of the invention, the forwardly extending contact portion of at least one of the connector terminals is disposed in a slot in the base of the housing. The slot is bounded on at least one side thereof by an upstanding rib. The baffle surface is on an outside surface of the rib. The second switch terminal has a bearing surface for riding along the top of the upstanding rib. The baffle projection projects downwardly from the bearing surface.

The first switch terminal includes a body portion mounted on the housing near the rear terminal-mounting section thereof. A flexible contact arm extends from the body portion at an angle forwardly into the cavity, and the contact portion of the first switch terminal is at a distal end of the flexible contact arm. The memory card connector is adapted for mounting on a printed circuit board, and the first switch terminal includes a foot portion for connection to an appropriate circuit trace on the printed circuit board. Accordingly, the connector terminals include tail portions outside the housing for connection to appropriate circuit traces on the printed circuit board.

The second switch terminal includes a body portion mounted on the rear terminal-mounting section of the housing. The flexible contact arm of the second switch terminal extends from the body portion at an angle forwardly into the cavity in front of the flexible contact arm of the first switch terminal. The second switch terminal also includes a foot portion for connection to an appropriate circuit trace on the printed circuit board.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a conventional memory card connector according to the prior art;

FIG. 2 is a perspective view similar to that of FIG. 1, but of another memory card connector according to the prior art, with the second switch terminal lifted from the connector housing;

FIG. 3 is a view similar to that of FIG. 2, but of a memory card connector according to the present invention;

FIG. 3A is an enlarged depiction of the circled area [symbol] A [symbol] in FIG. 3;

FIG. 4 is a perspective view similar to that of FIG. 3, with the second switch terminal mounted to the housing;

FIG. 5 is a top plan view of the connector of FIGS. 3 and 4;

FIG. 6 is a perspective view of the second switch terminal; and

FIG. 7 is a top plan view of the second switch terminal.

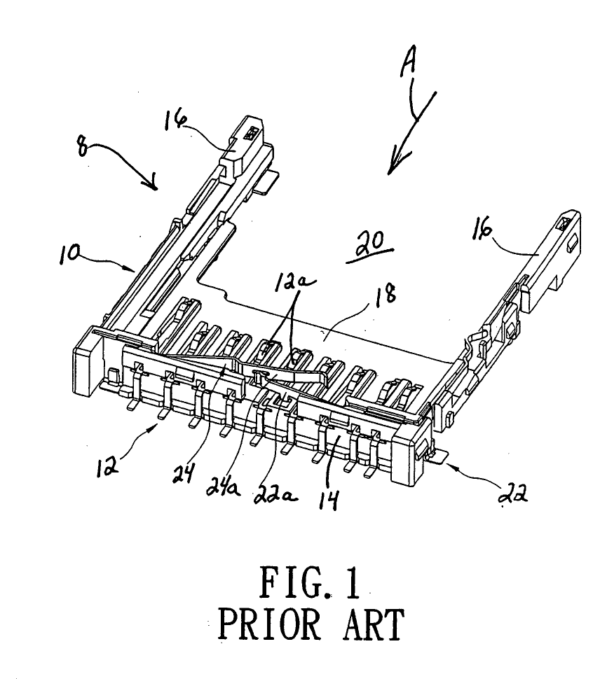

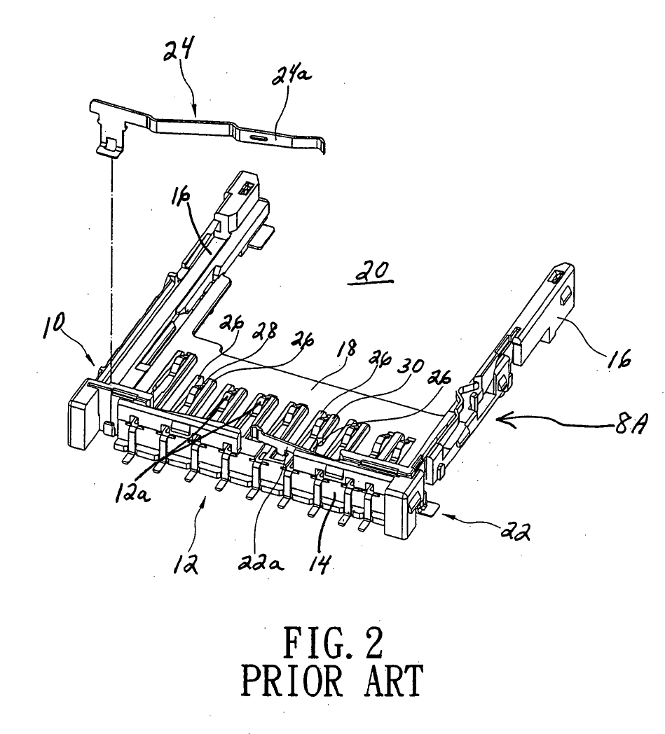

### DETAILED DESCRIPTION OF THE PREFERRED EMBODIMENT

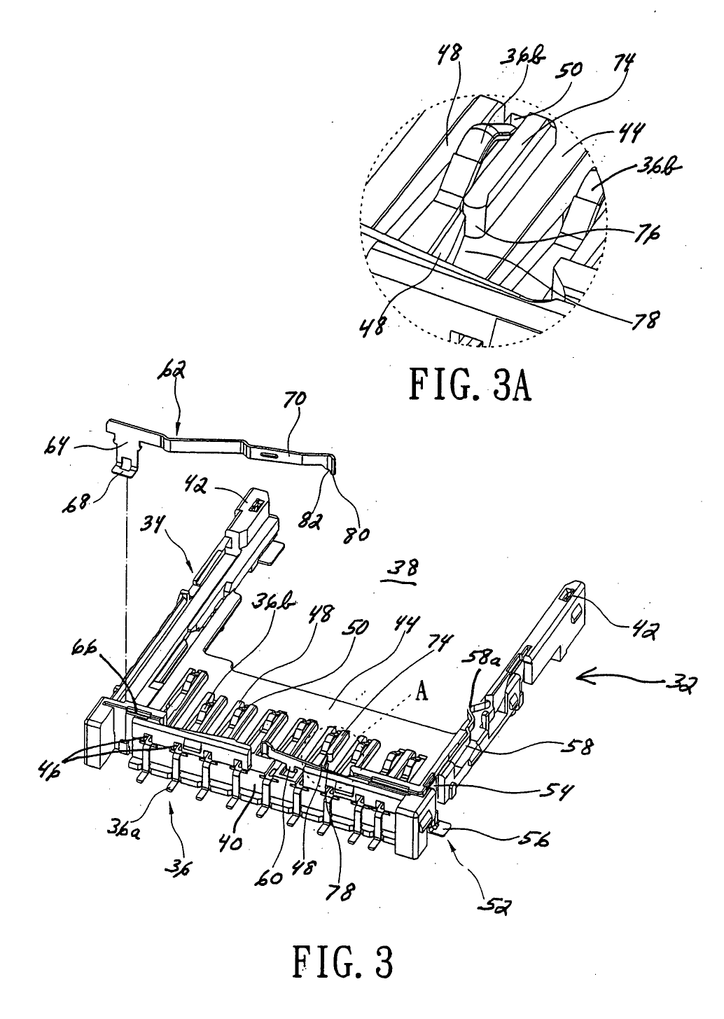

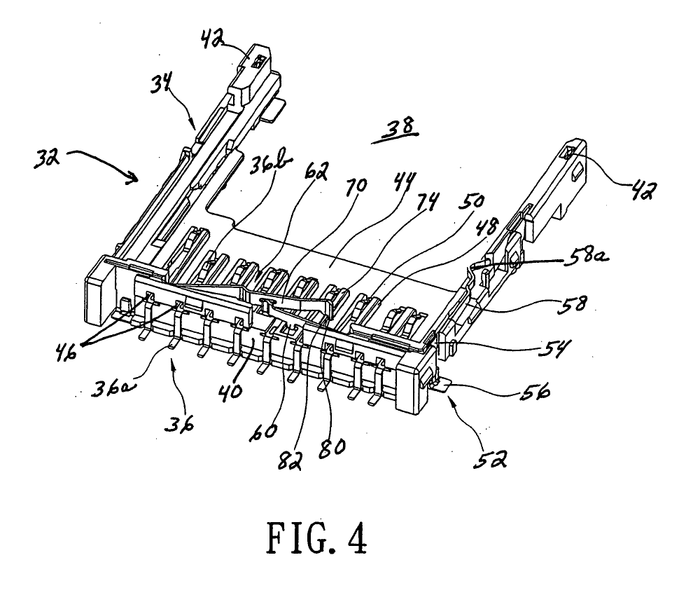

Referring to the drawings in greater detail, and first to FIGS. 3-5, the invention is embodied in a memory card connector, generally designated 32, which includes a one-piece insulative housing, generally designated 34, which mounts a plurality of connector terminals, generally designated 36. The housing is fabricated of insulating material such as molded plastic. A metal shell or cover (not shown) typically is mounted on top of the housing. The cover and the housing combine to form an interior card-receiving cavity 38 which permits insertion and removal of a memory card into and out of the connector.

The molded plastic housing 34 of connector 32 may be generally U-shaped (as shown) or L-shaped (not shown). In either event, the housing has a rear terminal-mounting section 40 which traverses the rear of cavity 38, along with a pair of longitudinal side wall sections 42 which extend forwardly from both ends of the rear section to define opposite sides of cavity 38. The housing has a bottom plate or base 44 which spans the bottoms of side wall sections 42 and projects forwardly from rear terminal-mounting section 40. The housing is adapted for mounting on top of a printed circuit board (not shown).

Terminals 36 are mounted within a plurality of through passages 46 in rear terminal-mounting section 40 of the housing. Each terminal includes a tail portion 36a which is generally flush with the bottom surface of the housing for connection, as by soldering, to appropriate circuit traces on the printed circuit board. Terminals 36 also have contact portions 36b which extend forwardly for engaging appropriate contacts on the memory card, such as at the bottom of the card. A plurality of upstanding pairs of ribs 48 define grooves 50 therebetween, with contact portions 36b of the connector terminals disposed in the grooves. In other words, there is a pair of upstanding ribs 48 defining a groove 50 therebetween for each contact portion 36b. The ribs prevent contact portions 36b from swinging laterally and prevent connector terminals 36 from loosening.

A first switch terminal, generally designated 52, includes a body portion 54 mounted in the housing. A foot portion 56 projects outwardly of the housing for connection, as by soldering, to an appropriate circuit trace on the printed circuit board. First switch terminal 52 is generally L-shaped and includes a forwardly extending resilient arm 58 which has a locking portion 58a at the distal end thereof for lockingly engaging a recess at a side edge of the memory card. A flexible contact arm 60 projects generally at a right angle to arm 58 and extends from body portion 54 at a slight angle forwardly into cavity 38 immediately in front of rear terminal-mounting section 40 of the housing.

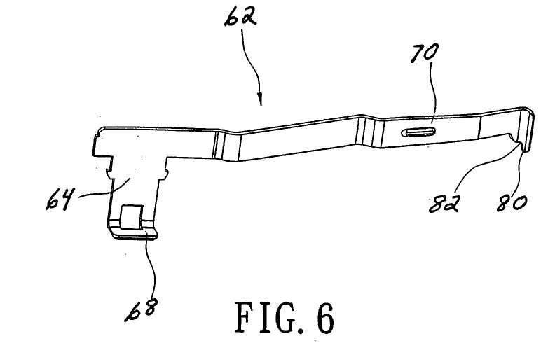

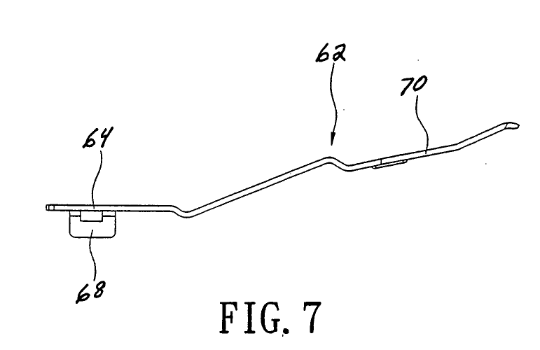

Referring to FIGS. 6 and 7 in conjunction with FIGS. 3-5, a second switch terminal, generally designated 62, includes a body portion 64 mounted in a slot 66 (FIG. 3) in rear terminal-mounting section 40 of housing 34. A foot portion 68 projects outwardly from body portion 64 for connection, as by soldering, to an appropriate circuit trace on the printed circuit board. A flexible contact arm 70 is cantilevered from body portion 64 at an angle outwardly into cavity 38 away from rear terminal-mounting section 40 of the housing and in front of contact arm 60 of first switch terminal 52.

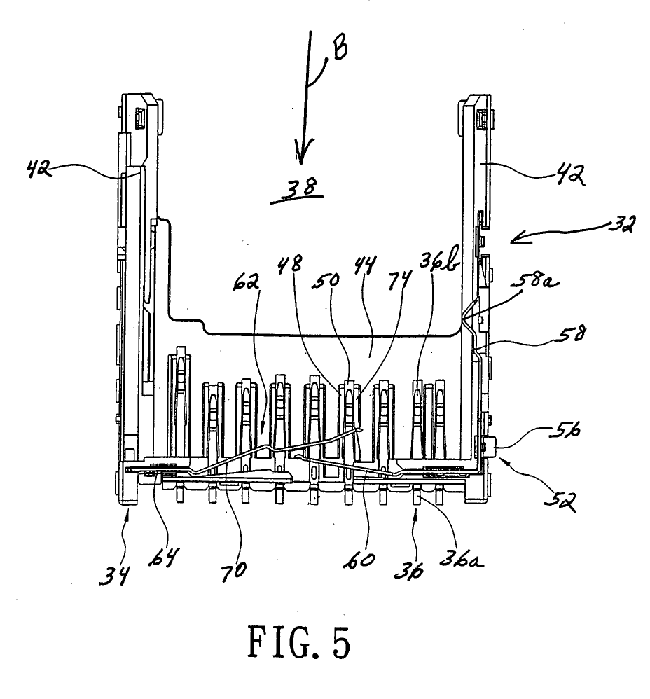

As best seen in FIG. 5, when a memory card is inserted into connector 32 in the direction of arrow “B”, a leading edge of the memory card will engage flexible contact arm 70 of second switch terminal 62 and move the flexible contact arm into engagement with contact arm 60 of first switch terminal 52 to effectively close the “switch” formed by the two switch terminals. Both switch terminals are fabricated (as by stamping and forming) from conductive sheet metal material of high conductivity.

According to the invention, and referring particularly to FIG. 3A in conjunction with FIGS. 3-5, a baffle block or flange 74 is molded integrally with base 44 of the housing between the contact portions 36b of a pair of connector terminals 36. Actually, as seen in FIG. 3A, baffle block or flange 74 is part of or a continuation of one of the upstanding ribs 48 which forms one of the grooves 50 for one of the contact portions 36b. Baffle block 74 projects upwardly or higher than the upstanding rib, as can be seen. A rear end of baffle block 74 forms a baffle surface or stop surface 76. A notch 78 is effectively formed behind stop surface 76. Referring back to FIGS. 3 and 6, second switch terminal 62 has a depending baffle projection 80 which extends downwardly from a bearing surface 82 at the distal end of flexible contact arm 70.

Therefore, and referring to FIGS. 5 and 6 in conjunction with FIG. 3A, when second switch terminal 62 is mounted on the housing of connector 32, flexible contact arm 70 is angled forwardly into cavity 38 in front of contact arm 60 of first switch terminal 52 as seen in FIG. 5. When so mounted, the downwardly extending baffle projection 80 (FIG. 6) is located in notch 78 (FIG. 3A) behind the baffle or stop surface 76 of baffle block 74. Bearing surface 82 can ride on upstanding rib 48 (FIG. 3A) so that flexible contact arm 70 does not engage contact portions 36b of the connector terminals. Additionally, the location of depending baffle projection 80 (FIG. 6) in notch 78 (FIG. 3A) locates the flexible contact arm and stop surface 76 prevents the arm from being dislocated or pulled outwardly during handling or assembly. Therefore, the invention not only prevents flexible contact arm 70 of the second switch terminal from engaging, damaging and/or shorting contact portions 36b of connector terminals 36, but the flexible contact arm, itself, is protected from dislocation and/or bending because of the interengagement of depending baffle projection 80 within notch 78 and against stop surface 76.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. What is claimed is 1. A memory card connector having a cavity for receiving a memory card, comprising:
an insulative housing having a rear terminal-mounting section at the rear of the cavity and which mounts a plurality of connector terminals having forwardly extending contact portions for engaging appropriate contacts on the memory card, the housing having a base forwardly of the rear terminal-mounting section, and the base having a baffle surface located between a pair of said forwardly extending contact portions;
a first switch terminal mounted on the housing and having a contact portion near the rear of the cavity; and
a second switch terminal mounted on the housing and having a flexible contact arm engageable by the memory card and movable by the card into engagement with the contact portion of the first switch terminal, the flexible contact arm having a depending baffle projection engageable with the baffle surface on the base of the housing for locating the flexible contact arm.

2. The memory card connector of claim 1 wherein the forwardly extending contact portion of at least one of the connector terminals is disposed in a groove in the base of the housing, the groove being bounded on at least one side thereof by an upstanding rib, and said baffle surface being on an outside surface of the rib.

3. The memory card connector of claim 2 wherein said second switch terminal has a bearing surface for riding along the top of said upstanding rib.

4. The memory card connector of claim 3 wherein said baffle projection projects downwardly from said bearing surface.

5. The memory card connector of claim 1 wherein said second switch terminal includes a body portion mounted on the rear terminal-mounting section of the housing, and said flexible contact arm extends from the body portion at an angle forwardly into the cavity.

6. The memory card connector of claim 5 wherein said second switch terminal includes a foot portion for connection to an appropriate circuit trace on a printed circuit board.

7. The memory card connector of claim 1 wherein said first switch terminal includes a body portion mounted on the housing near the rear terminal-mounting section thereof, and a flexible contact arm extending from the body portion at an angle forwardly into the cavity, said contact portion being at a distal end of the flexible contact arm.

8. The memory card connector of claim 7 wherein said first switch terminal includes a foot portion for connection to an appropriate circuit trace on a printed circuit board.

9. The memory card connector of claim 1 wherein said connector terminals include tail portions outside the housing for connection to appropriate circuit traces on the printed circuit board.

10. A memory card connector having a cavity for receiving a memory card, comprising:
an insulative housing for mounting on a printed circuit board and having a rear terminal-mounting section at the rear of the cavity and which mounts a plurality of connector terminals having forwardly extending contact portions for engaging appropriate contacts on the memory card, the terminals having tail portions outside the housing for connection to appropriate circuit traces on the printed circuit board, the housing having a base forwardly of the rear terminal-mounting section, and the base having a baffle surface located between a pair of said forwardly extending contact portions;
a first switch terminal including a body portion mounted on the housing near the rear terminal-mounting section thereof, a flexible contact arm extending from the body portion at an angle forward into the cavity at the rear thereof, a contact portion at a distal end of the flexible contact arm, and a foot portion for connection to an appropriate circuit trace on the printed circuit board; and
a second switch terminal including a body portion mounted on the rear terminal-mounting section of the housing, a flexible contact arm extending from the body portion at an angle forwardly into the cavity and engageable by the memory card and movable by the card into engagement with the contact portion of the first switch terminal, and a foot portion for connection to an appropriate circuit trace on a printed circuit board, the flexible contact arm having a depending baffle projection engageable with the baffle surface on the base of the housing for locating the flexible contact arm and preventing the arm from flexing outwardly into the cavity.

11. The memory card connector of claim 10 wherein the forwardly extending contact portion of at least one of the connector terminals is disposed in a groove in the base of the housing, the groove being bounded on at least one side thereof by an upstanding rib, and said baffle surface being on an outside surface of the rib.

12. The memory card connector of claim 11 wherein said second switch terminal has a bearing surface for riding along the top of said upstanding rib.

13. The memory card connector of claim 12 wherein said baffle projection projects downwardly from said bearing surface.
